(19) United States
(12) Patent Application Publication
(10) Pub. No.: US 2009/0251846 A1
(43) Pub. Date: Oct. 8, 2009

(54) EMBEDDED CAPACITOR

(75) Inventors: Jae Chan LEE, Suwon-si (KR); Eun Sung LEE, Seoul (KR); Yoo Seong YANG, Daejeon (KR)

Correspondence Address: CANTOR COLBURN, LLP, 20 Church Street, 22nd Floor, Hartford, CT, 06103, US

(73) Assignee: SAMSUNG ELECTRO-MECHANICS CO., LTD., Suwon-si (KR)

(21) Appl. No.: 12/246,030

(22) Filed: Oct. 6, 2008

(30) Foreign Application Priority Data
Apr. 2, 2008 (KR) 10-2008-0030754

(51) Int. Cl. H01G 4/002

(52) U.S. Cl. 361/301.3; 29/25.42

(57) ABSTRACT

An embedded capacitor including a dielectric layer disposed between opposing faces of electrodes, in which the dielectric layer includes a high-loss dielectric layer and one or more insulating layers in contact with the high-loss dielectric layer. The dielectric layer may have a two-layer structure or a three-layer structure in which an insulating layer is additionally interposed between the high-loss dielectric layer and the electrode, thereby decreasing the dielectric loss while maintaining a high dielectric constant, compared to capacitors including a single-layer dielectric structure.

This non-provisional application claims priority to Korean Patent Application No. 10-2008-0030754, filed on Apr. 2, 2008, and all the benefits accruing therefrom under U.S.C. §119, the content of which is incorporated herein by reference in their entirety.

### BACKGROUND

1. Field

This disclosure is directed to an embedded capacitor, and more particularly, to an embedded capacitor including a dielectric layer having a two-layer structure or a three-layer structure in which an insulating layer is additionally interposed between a high-loss dielectric layer and an electrode, to thereby decrease dielectric loss while maintaining a high dielectric constant.

2. Description of the Related Art

Recent industrial trends in electronic products have become increasingly directed to mobile products, which dominate technological development and markets. There is therefore an interest in decreasing the size and weight of mobile products and increasing the performance of such devices. With the further miniaturization of passive devices, the manufacture and mounting of such devices becomes more difficult, and therefore techniques have been proposed for directly forming passive devices, including resistors, inductors, and capacitors, in printed circuit boards (“PCB”), instead of having such devices mounted on the PCB.

An embedded capacitor decreases the surface area of the substrate of a product, making it possible to decrease the size and weight of a product. Further, embedded capacitors may be located near the input terminal of active devices so that the length of lead wires is minimized, thereby drastically reducing inductance and resulting in improved electrical performance. Furthermore, the embedded capacitor is advantageous because it desirably eliminates high-frequency noise and decreases the number of solder joints, further increasing the reliability of a device comprising the embedded capacitor, and decreasing the manufacturing cost.

An embedded capacitor can be fabricated to have a capacitance of from 1 pF to 1 μF or more depending on the type of material for electronic parts. In order to ensure an accurate capacitance for the embedded capacitor, it is important to achieve a high dielectric constant for the capacitor dielectric and low dielectric loss. Hence, embedded capacitors that maintain a high dielectric constant and that have low dielectric loss are desirable.

### SUMMARY

Disclosed herein is an embedded capacitor, which maintains a high dielectric constant and realizes low dielectric loss.

Also disclosed herein is a device including the embedded capacitor having improved dielectric properties, such as a high dielectric constant and low dielectric loss.

In an embodiment, an embedded capacitor including an upper electrode, a lower electrode, and a dielectric layer formed between opposing surfaces of the upper electrode and the lower electrode is provided, in which the dielectric layer includes a high-loss dielectric layer and one or more insulating layers in contact with the high-loss dielectric layer.

The embedded capacitor may have a two-layer structure, in which the high-loss dielectric layer may be formed on a surface of a lower electrode and an insulating layer may be formed on a surface of the high-loss dielectric layer opposite the lower electrode, or in which the insulating layer may be formed on a surface of the lower electrode and the high-loss dielectric layer may be formed on a surface of the insulating layer opposite the lower electrode. In another embodiment, the embedded capacitor may have a three-layer structure, in which two insulating layers, a first insulating layer and a second insulating layer, may be disposed between the upper electrode and the lower electrode, the first insulating layer in contact with a surface of the upper electrode and the second insulating layer in contact with a surface of the lower electrode, respectively, and the high-loss dielectric layer may be interposed between the two insulating layers and in at least partial contact with a surface of each of the first and second insulating layers.

The high-loss dielectric layer has a dielectric loss of about 10% to about 1000%, and contains a composite comprising a polymer resin and a conductive material. The insulating layer may comprise one or more selected from the group consisting of SiNx where 0<x<1.33; SiOx where 0<x<2; Al₂O₃; polyvinylphenol; polymethylmethacrylate; polyacrylate; polyvinylalcohol; metal oxide; metal nitride; and metal sulfide. Also, the thickness of the insulating layer may be from 10 nm to 1,000 nm.

In another embodiment, a method of forming an embedded capacitor comprises forming a lower electrode, forming a dielectric layer on a surface of the lower electrode, and forming an upper electrode on a surface of the dielectric layer.

In another embodiment, a device comprising the above embedded capacitor is provided. The device may include, for example, a printed circuit board (“PCB”), a portable two-way radio, a daughterboard, a hand-held product, or the like.

### BRIEF DESCRIPTION OF THE DRAWINGS

The embodiments will be more clearly understood from the following detailed description taken in conjunction with the accompanying drawings, in which:

FIG. 1 is a cross-sectional view illustrating an exemplary embedded capacitor;

FIG. 2 is another cross-sectional view illustrating an exemplary embedded capacitor;

FIG. 3 is a further cross-sectional view illustrating an exemplary embedded capacitor;

FIG. 4 is a graph illustrating the capacitance of the exemplary embedded capacitor depending on the thickness of SiO₂; and

FIG. 5 is a graph illustrating the dielectric loss of the exemplary embedded capacitor depending on the thickness of SiO₂.

### DETAILED DESCRIPTION OF EMBODIMENTS

Hereinafter, a detailed description will be given of an embedded capacitor according to embodiments with reference to the accompanying drawings. The thickness of the layers or regions shown in the drawings is exaggeratedly depicted for clarity of the description.

In an embodiment, an embedded capacitor comprises electrodes and a dielectric layer disposed therebetween, in which the dielectric layer includes a high-loss dielectric layer and one or more insulating layers in contact with the high-loss dielectric layer.

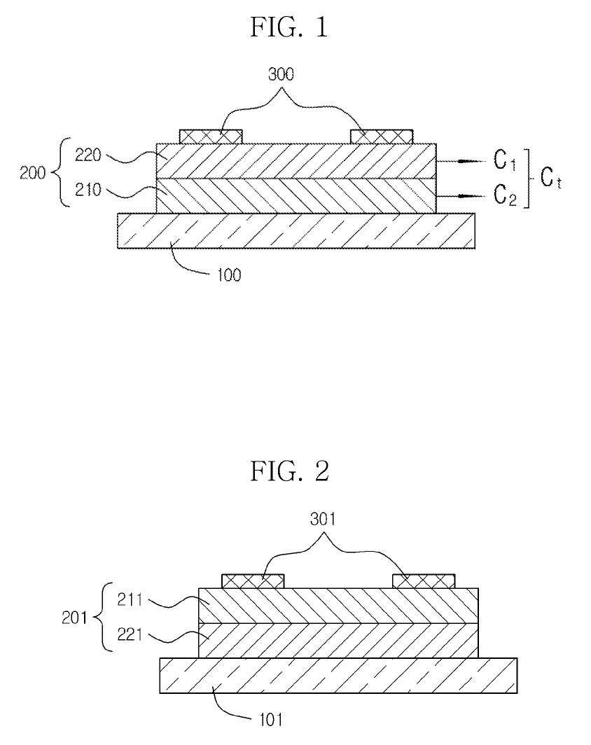

The embedded capacitor includes a multilayered dielectric layer, and the multilayered dielectric layer may have a two-layer structure or a three-layer structure. FIGS. 1 to 3 are cross-sectional views schematically illustrating an embodiment of the embedded capacitor. FIG. 1 is an exemplary cross-sectional view of the embedded capacitor having a two-layer structure. As seen in FIG. 1, the embedded capacitor includes a lower electrode 100, an upper electrode 300, and a dielectric layer 200 disposed between and in at least partial contact with opposing surfaces of the lower electrode 100 and the upper electrode 300. The dielectric layer 200 further comprises a high-loss dielectric layer 210 disposed on a surface of the lower electrode 100 and an insulating layer 220 disposed on a surface of the high-loss dielectric layer 210 opposite the lower electrode 100, and where a surface of the insulating layer 220 opposite the high dielectric layer 210 is also in partial contact with a surface of the upper electrode 300.

In another embodiment, the embedded capacitor may have the structure shown in FIG. 2, which is a cross-sectional view illustrating an embedded capacitor having a two-layer structure. As seen in FIG. 2, the embedded capacitor includes a lower electrode 101, an upper electrode 301, and a dielectric layer 201 between the lower electrode 101 and the upper electrode 301. In FIG. 2, dielectric layer 201 comprises an insulating layer 221 disposed on a surface of lower electrode 101, a high-loss dielectric layer 211 disposed on a surface of the insulating layer 221 opposite the lower electrode 101, and an upper electrode 301 disposed on a surface of the high-loss dielectric layer 211 opposite insulating layer 221. In this embedded capacitor, the dielectric layer 201 may have a high-loss dielectric layer 211 and an insulating layer 221 disposed on the lower surface of the high-loss dielectric layer 211.

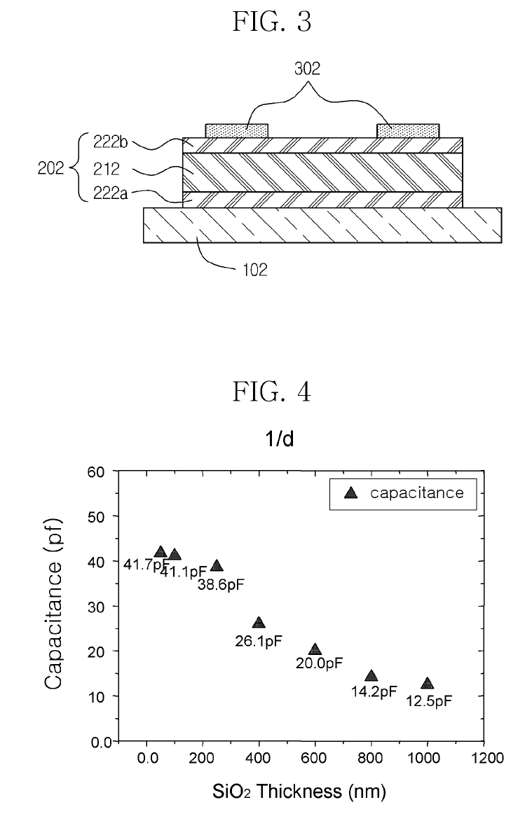

In another embodiment, the embedded capacitor may have the structure shown in FIG. 3, which is a cross-sectional view illustrating the embedded capacitor having a three-layer structure. As seen in FIG. 3, the embedded capacitor may include a dielectric layer 202, in which a high-loss dielectric layer 212 is disposed between two insulating layers 222a and 222b. Thus, in FIG. 3, a first insulating layer 222a is disposed on a surface of the lower electrode 102, a high-loss dielectric layer 212 is disposed on a surface of insulating layer 222a opposite lower electrode 102, a second insulating layer 222b is disposed on a surface of the high-loss dielectric layer 212 opposite the first insulating layer 222a, and an upper electrode 302 is disposed on a surface of the second dielectric layer 222b opposite high-loss dielectric layer 212.

In yet another embodiment, a method of decreasing the dielectric loss in an embedded capacitor is provided, in which the embedded capacitor has a lower electrode, an upper electrode, and a dielectric layer disposed between the lower electrode and upper electrode, the method comprising forming an insulating layer between the dielectric layer and the lower electrode, the upper electrode, or both the lower and upper electrodes, wherein the embedded capacitor has reduced dielectric loss when compared to an embedded capacitor prepared without the insulating layer.

The insulating layers 220 (in FIG. 1), 221 (in FIG. 2), and 222 (in FIG. 3) function to decrease the dielectric loss of the embedded capacitor. Thus, the embedded capacitor includes the dielectric layers 200 (in FIG. 1), 201 (in FIG. 2), 202 (in FIG. 3), respectively composed of the high-loss dielectric layers 210 (in FIG. 1), 211 (in FIG. 2), 212 (in FIG. 3) for accumulating electricity and one or more insulating layers 220, 221, 222 disposed on the upper surface and/or the lower surface of the high-loss dielectric layers 210, 211, 212, thereby realizing lower dielectric loss compared to capacitors consisting of a single dielectric layer.

Examples of material for the insulating layer include, but are not limited to, one or more selected from the group consisting of SiNx wherein 0<x<1.33; SiOx wherein 0<x<2; Al₂O₃; polyvinylphenol; polymethylmethacrylate; polyacrylate; polyvinylalcohol; metal oxide; metal nitride; and metal sulfide.

Although the thickness of the insulating layer is not particularly limited, thicknesses of from 10 nm to 1000 nm are useful, so that the dielectric loss of the embedded capacitor may be decreased to 10% or less while ensuring the dielectric constant thereof.

The process of forming the insulating layer is not particularly limited. An appropriate process may be used to form the insulating layer depending on the type of material for the insulating layer. For example, where the insulating layer is formed of SiO₂, because the insulating properties can be ensured only when an amorphous SiO₂ film is formed through deposition at room temperature, an electron-beam (e-beam) evaporator may be used.

The dielectric loss of the high-loss dielectric layer may be from about 10% to about 1,000%, and the high-loss dielectric layer may contain a composite including a polymer resin and a conductive material. The high-loss dielectric layer 210, 211, 212 plays a role in accumulating electricity, depending on the dielectric constant of the high-loss dielectric layer. Examples of the conductive material include, but are not limited to, one or more selected from the group consisting of carbon black, carbon nanotubes, carbon nanowires, carbon fiber, metal, metal oxide, and graphite. Examples of the polymer resin include, but are not limited to, one or more selected from the group consisting of epoxy, polyimide, silicone polyimide, silicone, polyurethane, melamine, phenol, and benzocyclobutene. The composite may further include a binder or other organic additives.

The composite may be applied in the form of a mixture with a solvent on a substrate using a simple coating process, such as spin coating, electrophoretic deposition, casting, inkjet printing, spray coating, and offset printing.

The thickness of the high-loss dielectric layer 210, 211, 212 is not particularly limited, and can be from 10 μm to 30 μm.

Examples of material for the lower electrodes 100, 101, 102 and the upper electrodes 300, 301, 302, which are the opposite electrodes, include, but are not necessarily limited to, metals such as Cu, Ag, Pt, Au, Pd, Ni, Cr, Mo, or alloys thereof.

The substrate used in the manufacture of the capacitor can include a silicon substrate or an FR-4 (flame retardant epoxy prepreg) substrate. In the case of the silicon substrate, to increase the adhesive strength between the substrate and the lower electrode 100, 101, and 102, an adhesion layer may be further formed using Ti.

In another embodiment, a method of forming an embedded capacitor comprises forming a lower electrode, forming a dielectric layer on a surface of the lower electrode, and forming an upper electrode on a surface of the dielectric layer.

In a specific embodiment, forming the dielectric layer comprises forming a high-loss dielectric layer on a surface of the lower electrode, and forming an insulating layer on a surface of the high-loss dielectric layer opposite the lower electrode, wherein the upper electrode is in contact with the insulating layer.

In another specific embodiment, forming the dielectric layer comprises forming an insulating layer on a surface of the lower electrode, and forming a high-loss dielectric layer on a surface of the insulating layer opposite the lower electrode, wherein the upper electrode is in contact with the high-loss dielectric layer.

In another specific embodiment, forming the dielectric layer comprises forming a first insulating layer on a surface of the lower electrode, forming a high-loss dielectric layer on a surface of the first insulating layer opposite the lower electrode, and forming a second insulating layer on a surface of the high-loss dielectric layer opposite the first insulating layer, wherein the upper electrode is in contact with the second insulating layer.

It will be appreciated that multiple layers may be formed, or that a device comprising the embedded capacitor may include multiple embedded capacitors where more than one of the above embodiments for forming the capacitors may be employed.

In another embodiment, a method of decreasing the dielectric loss in an embedded capacitor is provided, in which the embedded capacitor has a lower electrode, an upper electrode, and a dielectric layer disposed between the lower electrode and upper electrode, the method comprising forming an insulating layer between the dielectric layer and the lower electrode, the upper electrode, or both the lower and upper electrodes, wherein the embedded capacitor has reduced dielectric loss when compared to an embedded capacitor prepared without the insulating layer.

In another embodiment, a device including the embedded capacitor is provided. Examples of the device include a printed circuit board (PCB), a portable two-way radio, a daughterboard, a hand-held product, and the like. The device includes the embedded capacitor, which is able to reduce dielectric loss while ensuring a high dielectric constant, thereby minimizing or preventing any risk of rapid heating or explosion of the device, and increasing the lifespan of the product.

A better understanding of the exemplary embodiments will be described in more detail with reference to the following examples. However, these examples are given merely for the purpose of illustration and should not be construed as limiting the scope of the embodiments thereto.

### EXAMPLE 1

Titanium (Ti) was deposited to a thickness of about 20 nm on a silicon substrate, after which copper (Cu) was deposited on the Ti surface to a thickness of about 300 nm and a diameter of 300 μm (total area: 0.2826 mm²), thus forming a lower electrode. Then, on a surface of the lower electrode, a paste comprising 1.577 g of cycloaliphatic epoxy, 0.160 g of carbon black (Ketjen Black 300, Mitsubishi), 1.051 g of 1,2-cyclohexanedicarboxylic anhydride, and 0.015 g of 1-methylimidazole was applied to a thickness of about 30 μm, thus forming a high-loss dielectric layer. Then, silica was deposited to a thickness of about 400 nm on the high-loss dielectric layer using an e-beam deposition, to form an insulating layer. Subsequently, Cu was deposited to a thickness of about 100 nm on the insulating layer, to form an upper electrode. The upper and lower electrodes of the capacitor were then connected in series, to provide a capacitor having a two-layer dielectric structure.

### EXAMPLES 2 TO 4

Capacitors of Examples 2, 3, and 4 were manufactured in the same manner as in Example 1, with the exception that the thickness of the insulating layer on the high-loss dielectric layer was changed to 600 nm, 800 nm and 1000 nm, respectively.

### COMPARATIVE EXAMPLE

Ti was deposited to a thickness of about 20 nm on an FR-4 substrate, after which Cu was deposited thereon to a thickness of about 300 nm and a diameter of about 300 μm (area: 0.2826 mm²), thus forming a lower electrode. Then, a paste comprising 1.577 g of cycloaliphatic epoxy, 0.160 g of carbon black (Ketjen Black 300, Mitsubishi), 1.051 g of 1,2-cyclohexanedicarboxylic anhydride, and 0.015 g of 1-methylimidazole was applied to a thickness of about 30 μm on the lower electrode, thus forming a high-loss dielectric layer. Then, Cu was deposited to a thickness of about 100 nm on the high-loss dielectric layer, thus forming an upper electrode. The upper and lower electrodes of the capacitor were then connected in series, to provide a capacitor having a two-layer dielectric structure.

### REFERENCE EXAMPLES 1 TO 4

In order to provide a reliable evaluation of the properties of the capacitors manufactured in the above examples, a single film of SiO₂ was simultaneously deposited on substrates as an insulating layer at a thickness of each of 400 nm, 600 nm, 800 nm and 1000 nm, using the same process as in Example 1 but without the inclusion of the dielectric layer.

### EXPERIMENTAL EXAMPLE

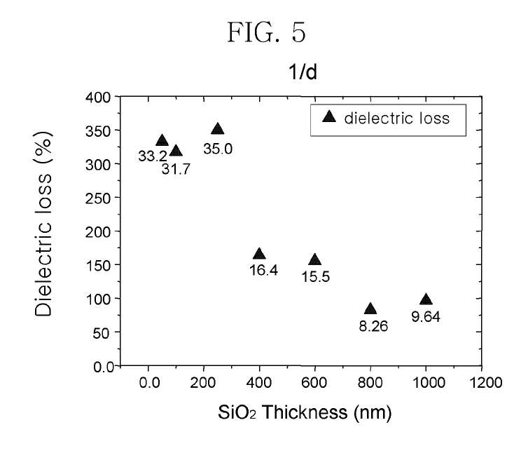

The dielectric layer of each of Examples 1 to 4, Comparative Example 1, and Reference Examples 1 to 4 was measured for dielectric constant and dielectric loss using an HP 4194A impedance analyzer operating at 1 kHz in the frequency range from 10 kHz to 10 MHz for an average measurement time of 4 sec/point. Under conditions in which the voltage that is applied was set to the range from −3.0 to +3.0 V and the applied voltage interval was set to 0.10 volt, capacitance and dielectric loss were measured. The results are given in Table 1 below. The graphs illustrating the capacitance and dielectric loss of the capacitors of the examples, depending on the thickness of SiO₂ layer, are also shown in FIGS. 4 and 5.

TABLE 1

| | Capacitance | | Dielectric Loss |
|---|---|---|---|
| | (pF) | ξᵣ | (%) |
| Ex. 1 | 26.1 | 918 | 16.4 |
| Ex. 2 | 20.0 | 706 | 15.5 |
| Ex. 3 | 14.2 | 500 | 8.26 |
| Ex. 4 | 12.5 | 441 | 9.64 |
| C. Ex. | 1850 | 47721 | 314.9 |
| Ref. Ex. 1 | 46.5 | 22.8 | 10.0 |
| Ref. Ex. 2 | 28.5 | 20.8 | 8.00 |
| Ref. Ex. 3 | 19.5 | 18.4 | 8.49 |
| Ref. Ex. 4 | 16.6 | 17.7 | 5.63 |

The above measured values were substituted into the following equations for calculating capacitance (C_{cb}) and dielectric constant (K_{cb}) for the capacitors and dielectric layers of the examples, comparative example, and reference examples, and thus the capacitance, dielectric constant, and dielectric loss of the composite high-loss dielectric layer of Examples 1 to 4 were calculated. The results are shown in Table 1.

$$< Capacitance > \\ {C}_{CB} \text{:} \frac{1}{{C}_{t}} = \frac{1}{{C}_{{SiO}_{2}}} + \frac{1}{{C}_{CB}} = \frac{{d}_{{SiO}_{2}}}{{k}_{{SiO}_{2}} {ξ}_{0} A} + \frac{{d}_{CB}}{{k}_{CB} {ξ}_{0} A}$$

$$\frac{1}{{C}_{CB}} = \frac{1}{{C}_{t}} - \frac{1}{{C}_{{SiO}_{2}}} \\ < Dielectric Constant > \\ {K}_{CB} \text{:} {C}_{CB} = \frac{{K}_{CB} {ξ}_{0} A}{{d}_{CB}} {K}_{CB} = \frac{{C}_{CB} {d}_{CB}}{{ξ}_{0} A}$$

wherein Cₜ: total capacitance of the entire dielectric layer, C_{SiO2}: capacitance of the insulating layer, C_{CB}: capacitance of the high-loss dielectric layer, d_{SiO2}: thickness of the insulating layer, d_{CB}: thickness of the high-loss dielectric layer, k_{SiO2}: dielectric constant of the insulating layer, k_{CB}: dielectric constant of the high-loss dielectric layer, ξₒ: vacuum dielectric constant (8.55×10⁻¹²), A: area of the electrode.

TABLE 2

| | | | Calculated Values | | |
|---|---|---|---|---|---|
| | Cₜ (pF) | C_{SiO2} (pF) | C_{CB} (pF) | K_{CB} | Dielectric Loss (%) |
| Ex. 1 | 26.1 | 46.5 | 59.3 | 2090 | 16.4 |
| Ex. 2 | 20.0 | 28.5 | 67.4 | 2373 | 15.5 |
| Ex. 3 | 14.2 | 19.5 | 52.0 | 1830 | 8.26 |
| Ex. 4 | 12.5 | 16.6 | 87.3 | 3075 | 9.64 |

As is apparent from Tables 1 and 2 and FIGS. 4 and 5, the embedded capacitor according to the Examples 1 to 4 can be seen to preserve the dielectric constant of a high-loss dielectric layer due to the presence of the insulating layer (SiO₂) which prevents dielectric loss. Further, as the thickness of the insulating layer is increased, capacitance and dielectric loss can also be seen to decrease.

Although the exemplary embodiments have been disclosed for illustrative purposes, those skilled in the art will appreciate that various modifications, additions and substitutions are possible, without departing from the scope and spirit of the invention as disclosed in the accompanying claims.

What is claimed is:

1. An embedded capacitor, comprising an upper electrode, a lower electrode, and a dielectric layer formed between opposing surfaces of the upper electrode and the lower electrode, wherein the dielectric layer comprises a high-loss dielectric layer and one or more insulating layers in contact with the high-loss dielectric layer.

2. The embedded capacitor of claim 1, wherein the high-loss dielectric layer is formed on a surface of the lower electrode and the insulating layer is formed on a surface of the high-loss dielectric layer opposite the lower electrode.

3. The embedded capacitor of claim 1, wherein the insulating layer is formed on a surface of the lower electrode and the high-loss dielectric layer is formed on a surface of the insulating layer opposite the lower electrode.

4. The embedded capacitor of claim 1, wherein two insulating layers are disposed between the upper electrode and the lower electrode to be in contact with opposing surfaces of the upper electrode and the lower electrode, respectively, and the high-loss dielectric layer is interposed between opposing surfaces of the two insulating layers.

5. The embedded capacitor of claim 1, wherein the high-loss dielectric layer contains a composite comprising a polymer resin and a conductive material.

6. The embedded capacitor of claim 5, wherein the conductive material comprises one or more selected from the group consisting of carbon black, carbon nanotubes, carbon nanowires, carbon fiber, metal, metal oxide, metal nanowire, metal fiber, and graphite.

7. The embedded capacitor of claim 5, wherein the polymer resin comprises one or more selected from the group consisting of epoxy, polyimide, silicone polyimide, silicone, polyurethane, melamine, phenol, and benzocyclobutane.

8. The embedded capacitor of claim 1, wherein the insulating layer comprises one or more selected from a group consisting of SiNx wherein 0<x<1.33; SiOx wherein 0<x<2; Al₂O₃; polyvinylphenol; polymethylmethacrylate; polyacrylate; polyvinylalcohol; metal oxide; metal nitride; and metal sulfide.

9. The embedded capacitor of claims 1, wherein the insulating layer has a thickness ranging from 10 nm to 1,000 nm.

10. The embedded capacitor of claim 1, wherein the embedded capacitor has less dielectric loss than a comparable embedded capacitor formed without the at least one insulating layer.

11. A device comprising the embedded capacitor of claim 1.

12. A method of forming an embedded capacitor, comprising
forming a lower electrode,
forming a dielectric layer on a surface of the lower electrode, and
forming an upper electrode on a surface of the dielectric layer.

13. The method of claim 12, wherein forming the dielectric layer comprises
forming a high-loss dielectric layer on a surface of the lower electrode, and
forming an insulating layer on a surface of the high-loss dielectric layer opposite the lower electrode,
wherein the upper electrode is in contact with the insulating layer.

14. The method of claim 12, wherein forming the dielectric layer comprises
forming an insulating layer on a surface of the lower electrode, and
forming a high-loss dielectric layer on a surface of the insulating layer opposite the lower electrode,
wherein the upper electrode is in contact with the high-loss dielectric layer.

15. The method of claim 12, wherein forming the dielectric layer comprises
forming a first insulating layer on a surface of the lower electrode,
forming a high-loss dielectric layer on a surface of the first insulating layer opposite the lower electrode, and
forming a second insulating layer on a surface of the high-loss dielectric layer opposite the first insulating layer,
wherein the upper electrode is in contact with the second insulating layer.

16. A method of decreasing the dielectric loss in an embedded capacitor having a lower electrode, an upper electrode, and a dielectric layer disposed between the lower electrode and upper electrode, comprising
forming an insulating layer between the dielectric layer and the lower electrode, the upper electrode, or both the lower and upper electrodes,
wherein the embedded capacitor has reduced dielectric loss when compared to an embedded capacitor prepared without the insulating layer.
